(19) United States
(12) Patent Application Publication
(10) Pub. No.: US 2021/0232191 A1
(43) Pub. Date: Jul. 29, 2021

(54) POWER SOURCE TIME DIVISION MULTIPLEX FOR THERMAL MANAGEMENT AND EXTENDED OPERATION

(71) Applicant: GoPro, Inc., San Mateo, CA (US)

(72) Inventors: Aaron O'Brien, San Clara, CA (US); Casimir Karczewski, Mountain View, CA (US); Sameer Mysore Venugopal, Milpitas, CA (US); Rajesh Madhur, San Jose, CA (US)

(21) Appl. No.: 17/157,939

(22) Filed: Jan. 25, 2021

Related U.S. Application Data
(60) Provisional application No. 62/967,256, filed on Jan. 29, 2020.

(51) Int. Cl. G06F 1/20; H01M 10/623; H01M 10/633

(52) U.S. Cl. CPC G06F 1/206; G03B 2217/007; H01M 10/633; H01M 10/623

(57) ABSTRACT

A method and apparatus may be used for power source time division multiplex for thermal management and extended operation. The apparatus includes a primary power source, a secondary power source, and a processor. The processor obtains an internal temperature measurement of the image capture device. The processor may determine a thermal zone based on the internal temperature measurement. In an example where the determined thermal zone is a first thermal zone, the processor may be configured to draw power from the secondary power source. In an example where the determined thermal zone is a second thermal zone, the processor may be configured to alternately draw power from the primary power source and the secondary power source. In an example where the determined thermal zone is a third thermal zone, the processor may be configured to draw power from the secondary power source.

### CROSS-REFERENCE TO RELATED APPLICATION(S)

This application claims priority to and the benefit of U.S. Provisional Patent Application No. 62/967,256, filed Jan. 29, 2020, the entire disclosure of which is hereby incorporated by reference.

### TECHNICAL FIELD

This disclosure relates to thermal management of one or more power sources.

### BACKGROUND

Some power sources, such as batteries, for example, generate heat during discharge. In a system that is thermally limited such that it generates more heat than it can dissipate, the temperature will continue to build until the system overheats, causing thermal shutdown and/or reduced run times for the batteries.

Typical solutions to extend the run time of a battery-operated system include the use of external or supplemental batteries. These systems typically consume power from the external or supplemental battery first until it is depleted, before consuming power from the internal or main battery. In these systems, the heat generated by the external or supplemental battery is external to the thermally limited product. However, when the external or supplemental battery is completely depleted, the thermally limited product begins drawing power from the internal or main battery causing heat to be generated inside the thermally limited product, causing the system to exceed temperature limits.

### SUMMARY

Disclosed herein are implementations of methods and devices for power source time division multiplex for thermal management and extended operation. In an aspect, an image capture device may include an image sensor, a primary power source, a secondary power source, and a processor. The image sensor may be configured to obtain an input image. The processor may be configured to obtain an internal temperature measurement of the image capture device. The processor may be configured to determine a thermal zone. The thermal zone may be based on the internal temperature measurement. In an example where the determined thermal zone is a first thermal zone, the processor may be configured to draw power from the secondary power source. In an example where the determined thermal zone is a second thermal zone, the processor may be configured to alternately draw power from the primary power source and the secondary power source. In an example where the determined thermal zone is a third thermal zone, the processor may be configured to draw power from the secondary power source.

In another aspect, an electronic device may include a sensor, a primary power source, a secondary power source, and a processor. The sensor may be configured to obtain an internal temperature measurement of the electronic device. The processor may be configured to determine a thermal zone. The thermal zone may be based on the internal temperature measurement. In an example where the determined thermal zone is a first thermal zone, the processor may be configured to draw power from the secondary power source. In an example where the determined thermal zone is a second thermal zone, the processor may be configured to alternately draw power from the primary power source and the secondary power source. In an example where the determined thermal zone is a third thermal zone, the processor may be configured to draw power from the secondary power source.

Another aspect may include a method for power source time division multiplex for thermal management and extended operation. The method may include obtaining an internal temperature measurement of an electronic device. The method may include determining a thermal zone. The thermal zone may be based on the internal temperature measurement. In an example where the determined thermal zone is a first thermal zone, the method may include drawing power from an external power source. In an example where the determined thermal zone is a second thermal zone, the method may include alternately drawing power from an internal power source and the external power source. In an example where the determined thermal zone is a third thermal zone, the method may include drawing power from the external power source.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial cross-sectional view of the image capture device of FIG. 2C.

FIG. 3 is a block diagram of electronic components of an image capture device.

FIG. 4 is a flow diagram of an example of a thermal management method.

FIG. 5 is a graph showing an example of power consumption between a primary power source and a secondary power source.

FIG. 6 is a graph showing another example of power consumption between a primary power source and a secondary power source.

FIG. 7 is a graph showing another example of power source consumption between a primary power source and a secondary power source.

FIG. 8 is a graph showing another example of power source consumption between a primary power source and a secondary power source.

FIG. 9 is a graph showing another example of power source consumption between a primary power source and a secondary power source.

### DETAILED DESCRIPTION

The embodiments disclosed herein may be implemented in any electronic device that has one or more power sources. A power source may be a battery that includes one or more electrochemical cells, including lithium ion (Li-ion) cells, nickel cadmium (NiCd) cells, nickel metal hydride (NiMH) cells, or any other suitable cells. A power source may include a sensor, for example, a temperature sensor, configured to determine a temperature measurement of the power source. The one or more power sources may be internal to an electronic device, external to the electronic device, or both. Some implementations may include more than one internal power source, more than one external power source, or both. The electronic device may include one or more sensors configured to obtain an internal temperature measurement of the electronic device. The electronic device may alternate power consumption between a primary power source, such as an internal battery, and a secondary power source, such as an external battery. In the implementations described herein, a primary power source may refer to a power source that is used for initial power draw. The primary power source may be an internal battery or an external battery. A secondary power source may refer to a power source that is not used for an initial power draw. The secondary power source may be an internal battery or an external battery.

In some implementations, drawing power from the primary power source may raise the internal temperature of the electronic device more than drawing power from the secondary power source. In some implementations, drawing power from the secondary power source may raise the internal temperature of the electronic device more than drawing power from the primary power source. The electronic device may be configured to adjust the amount of time that each battery supplies power to the electronic device to maximize the run time of the electronic device. In some implementations, the electronic device may be an image capture device.

As described herein, the electronic device may be configured to adjust the amount of time that each battery, internal and/or external, supplies power to the electronic device based on a thermal zone. The thermal zone may be identified based on an internal temperature measurement for the electronic device. The embodiments described herein may refer to a first thermal zone, a second thermal zone, a third thermal zone, or any combination thereof. Temperature ranges for the thermal zones may vary based on the power source type, power source health, system processor, electronic device size, electronic device geometry, arrangement of internal components, heat dissipation components, venting, attached accessories, mounting, airflow, electronic device thermal design, or any combination thereof. The temperature ranges for the thermal zones may be determined based on data from one or more temperature sensors configured to obtain temperature measurements of one or more critical components.

The implementations of this disclosure are described in detail with reference to the drawings, which are provided as examples so as to enable those skilled in the art to practice the technology. The figures and examples are not meant to limit the scope of the present disclosure to a single implementation or embodiment, and other implementations and embodiments are possible by way of interchange of, or combination with, some or all of the described or illustrated elements. Wherever convenient, the same reference numbers will be used throughout the drawings to refer to same or like parts.

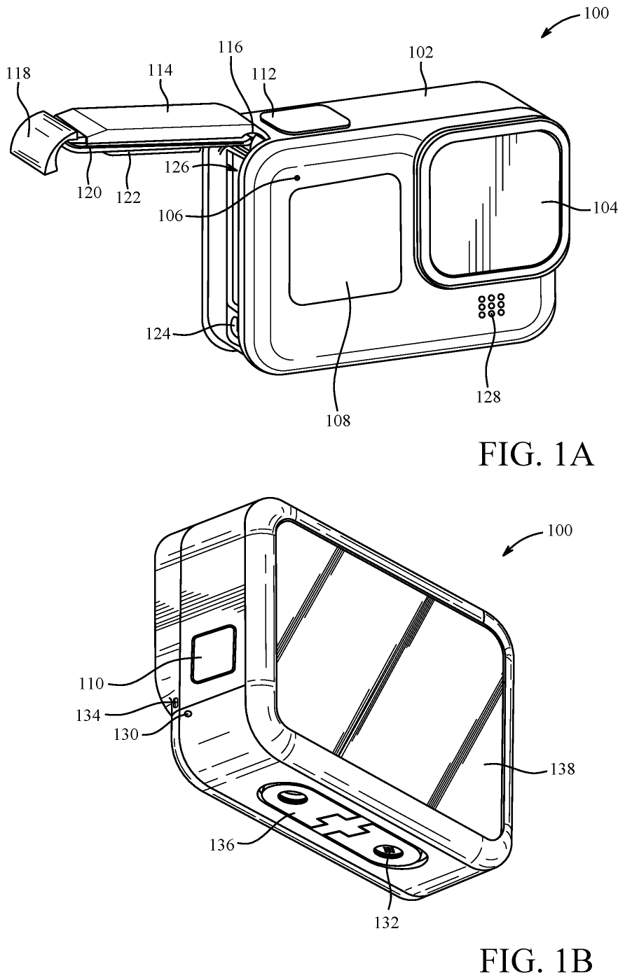

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

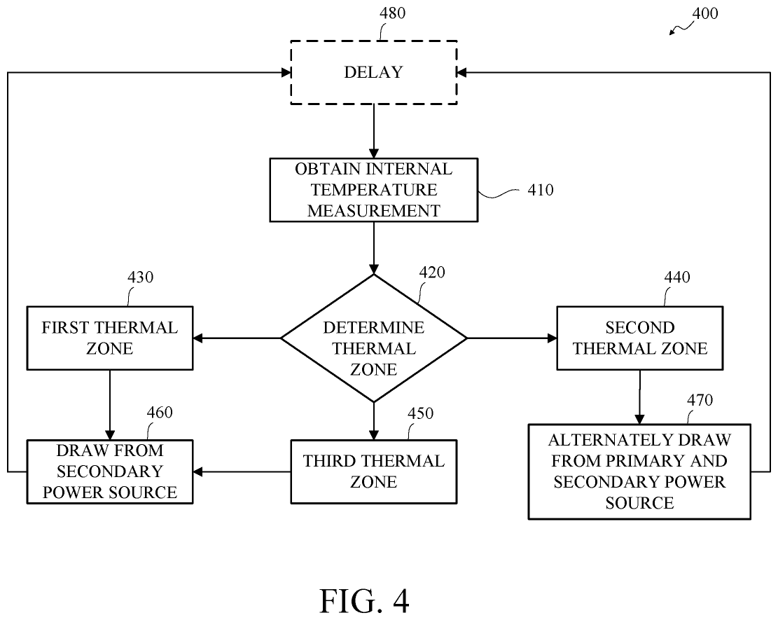

The image capture device 100 may be used to implement some or all of the techniques described in this disclosure, such as the technique 400 described in FIG. 4.

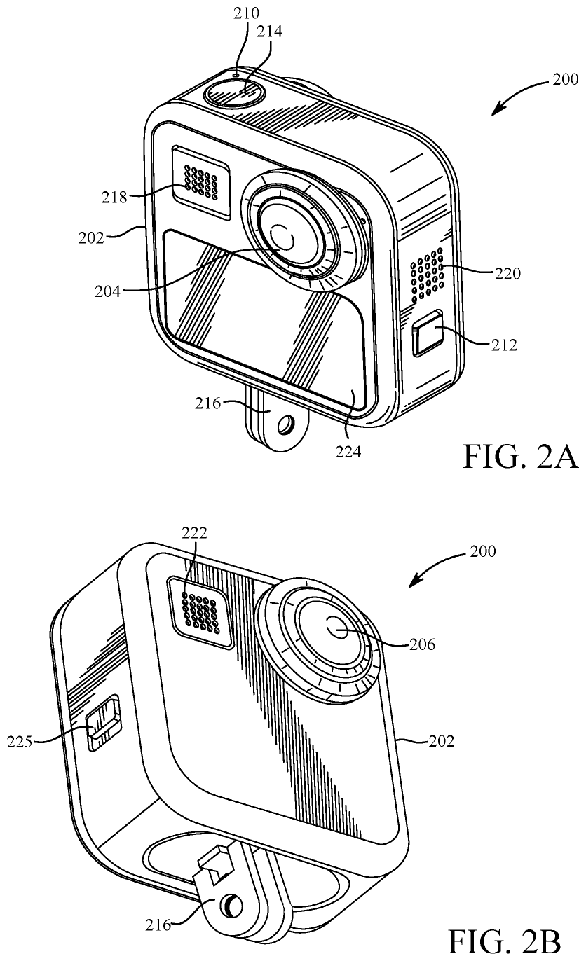

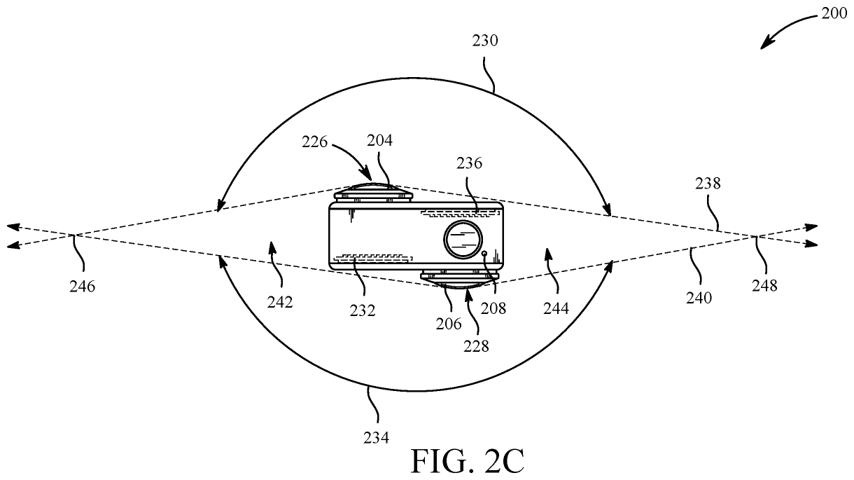

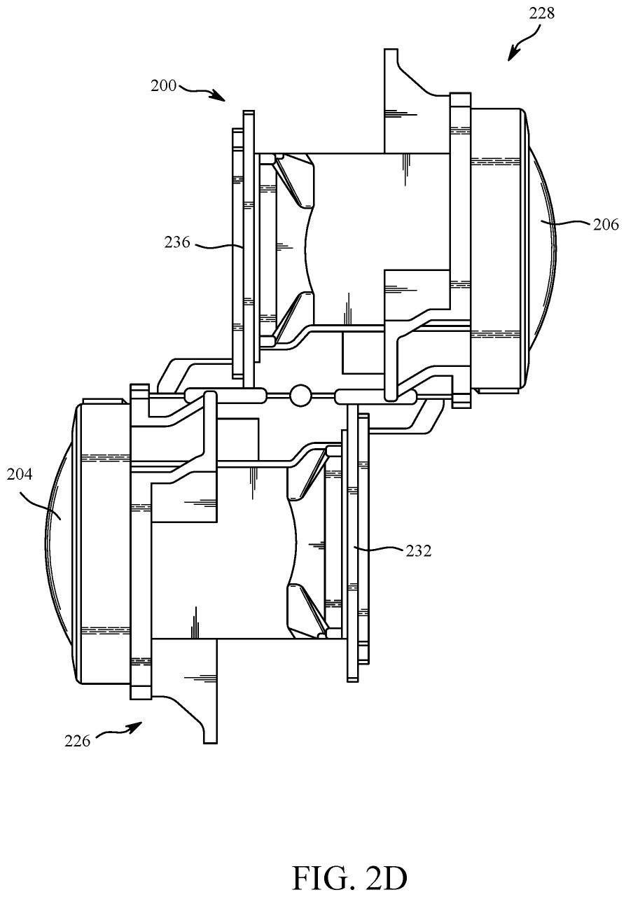

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

The image capture device 200 may be used to implement some or all of the techniques described in this disclosure, such as the technique 400 described in FIG. 4.

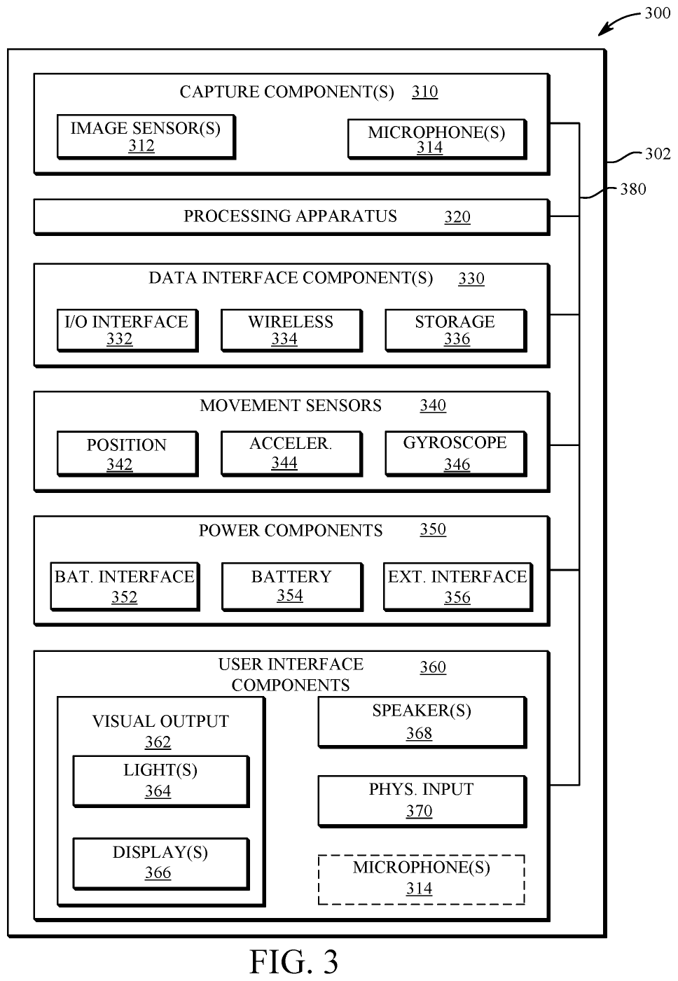

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

The image capture device 300 may be used to implement some or all of the techniques described in this disclosure, such as the technique 400 described in FIG. 4.

FIG. 4 is a flow diagram of an example of a thermal management method 400. The method 400 may be implemented in any electronic device, for example, an image capture device, such as the image capture device 100 shown in FIGS. 1A-B, the image capture device 200 shown in FIGS. 2A-D, or the image capture device 300 shown in FIG. 3. In this example, the image capture device includes a primary power source, such as an internal battery, and a secondary power source, such as an external battery.

Referring to FIG. 4, the method 400 includes obtaining 410 an internal temperature measurement. The internal temperature measurement may be obtained via a sensor. The sensor may be located on or near the processing apparatus 320 shown in FIG. 3 or in any suitable location internal to the housing of the image capture device. The method 400 includes determining 420 a thermal zone. The thermal zone may be determined based on the internal temperature measurement. Determining 420 a thermal zone may include determining whether the obtained internal temperature measurement is within a first thermal zone 430, a second thermal zone 440, or a third thermal zone 450. A determination that an electronic device is in a first thermal zone 430 indicates that the system is below a risk of overheating threshold (ROOT) and is not at risk of overheating. A determination that the electronic device is in the first thermal zone 430 may indicate that the system is cool. A determination that the electronic device is in a second thermal zone 440 indicates that the system is above the ROOT, and that the system will exceed a thermal limit of the system if the primary power source is used exclusively. A determination that the electronic device is in the second thermal zone 440 may indicate that the system is hot. A determination that the electronic device is in a third thermal zone 450 indicates that the system is above the ROOT and approaching the thermal limit of the system. A determination that the electronic device is in the third thermal zone 450 may indicate that the system is very hot.

In an example where it is determined that the electronic device is in the first thermal zone 430, the method 400 includes drawing 460 power from the secondary power source. In this example, power may be drawn from the secondary power source until the secondary power source is depleted. When the secondary power source is depleted, the electronic device may switch to draw power from the primary power source.

In an example where it is determined that the electronic device is in the second thermal zone 440, the method 400 includes alternately drawing 470 power from the primary and secondary power sources. The ratio of the power drawn from the primary and secondary power sources may vary based on battery type, capacity, battery health, battery age, device type, processor power requirements, or any combination thereof. The ratio of the power drawn from the primary and secondary power sources may be dynamically adjusted in real-time. Table 1 below shows some example power drawing ratios from the primary and secondary power sources. The ratios shown in Table 1 below are exemplary, and it is understood that any ratio may be used.

TABLE 1

| Primary Power Source (%) | Secondary Power Source (%) |
|---|---|
| 100 | 0 |
| 90 | 10 |
| 80 | 20 |
| 70 | 30 |
| 60 | 40 |
| 50 | 50 |
| 40 | 60 |
| 30 | 70 |
| 20 | 80 |
| 10 | 90 |
| 0 | 100 |

In an example where it is determined that the electronic device is in the third thermal zone 450, the method 400 includes drawing 460 power from the secondary power source. In this example, the system may still overheat if the secondary power source is used exclusively. In this example, power may be drawn from the secondary power source until the secondary power source is depleted. When the secondary power source is depleted, the electronic device may switch to draw power from the primary power source.

In some examples, the method 400 may include a delay 480. The delay 480 may be fixed or dynamic, and may be based on battery type, capacity, battery health, battery age, device type, processor power requirements, or any combination thereof.

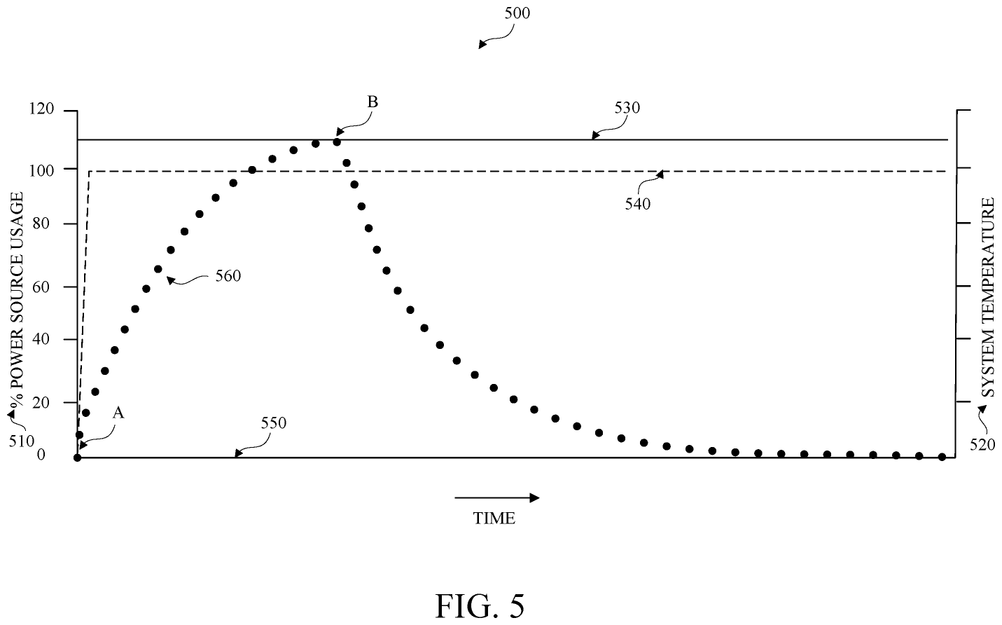

FIG. 5 is a graph 500 showing an example of power consumption between a primary power source and a secondary power source. The graph 500 shows a percent battery usage 510, system temperature 520 of an electronic device, and a thermal shutdown limit 530 of the electronic device. In this example, utilization of the primary power source 540 is exclusive, i.e., without the utilization of the secondary power source 550. As shown in FIG. 5, the electronic device begins drawing power from the primary power source at point A. As the electronic device continues drawing power from the primary power source, the system temperature 560 gradually increases until it reaches point B. At point B, the thermal shutdown limit 530 of the system is exceeded and causes a forced shutdown of the system. Upon the forced shutdown of the system, the system temperature 560 gradually decreases as the system cools.

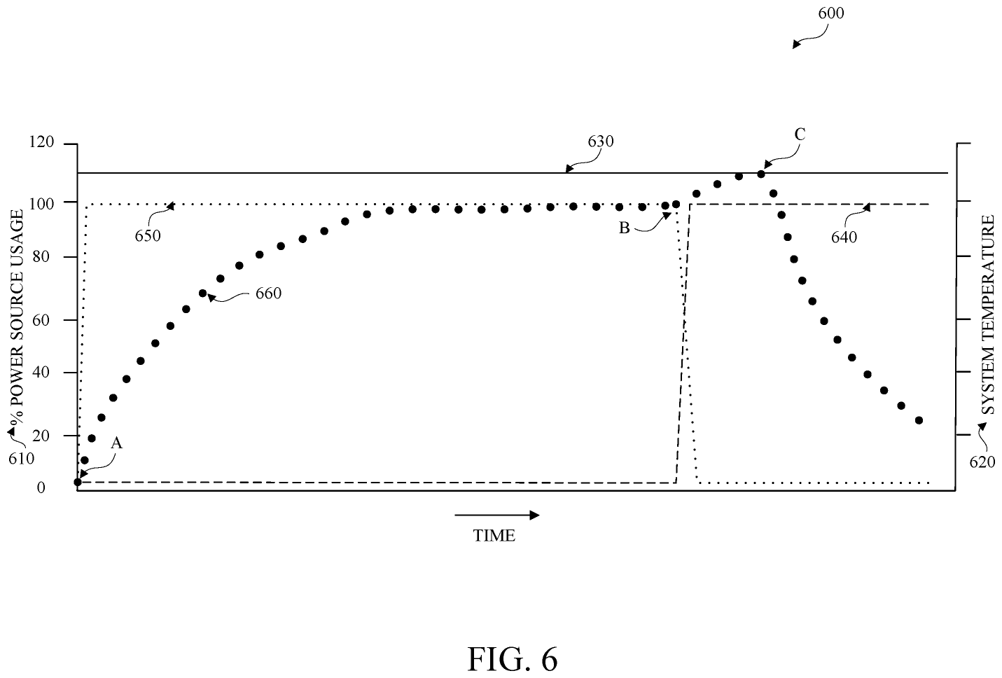

FIG. 6 is a graph 600 showing another example of power consumption between a primary power source and a secondary power source. The graph 600 is an example of the power consumption when it is determined that the electronic device is in the first thermal zone 430 or the third thermal zone 450 shown in FIG. 4. The graph 600 shows a percent battery usage 610, system temperature 620 of an electronic device, and a thermal shutdown limit 630 of the electronic device. In this example, utilization of the primary power source 640 is not initiated until the exclusive utilization of the secondary power source 650 depletes the secondary power source. As shown in FIG. 6, the electronic device begins drawing power from the secondary power source at point A. As the electronic device continues drawing power from the secondary power source, the system temperature 660 gradually increases until it reaches point B. At point B, the secondary power source is depleted, and the electronic device begins drawing power from the primary power source. As the electronic device continues drawing power from the primary power source, the system temperature 660 gradually increases until it reaches point C. At point C, the thermal shutdown limit 630 of the system is exceeded and causes a forced shutdown of the system. Upon the forced shutdown of the system, the system temperature 660 gradually decreases as the system cools.

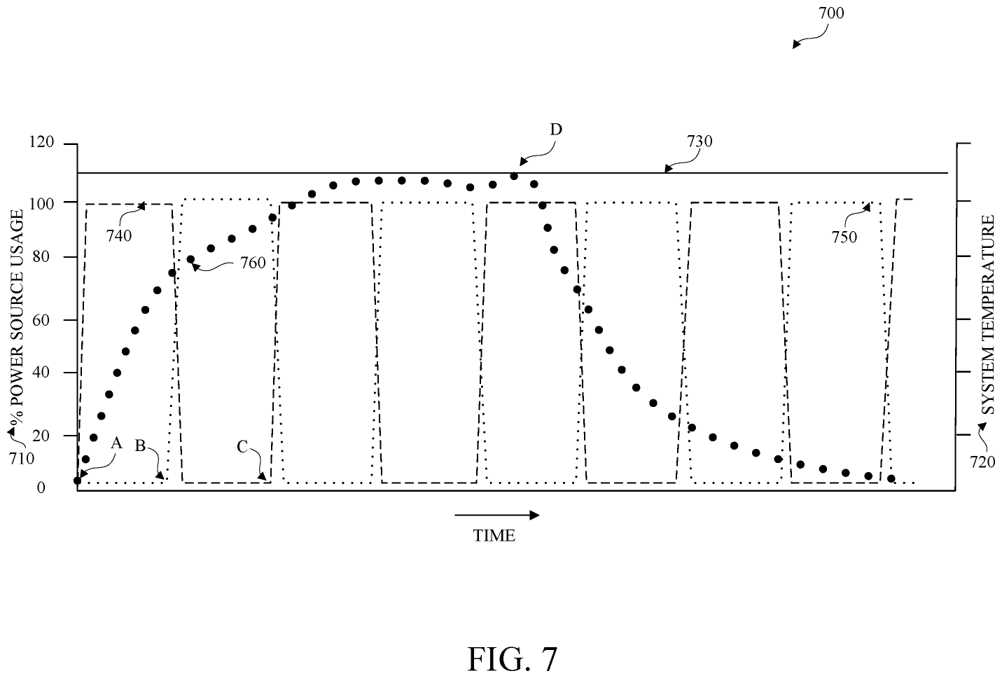

FIG. 7 is a graph 700 showing another example of power source consumption between a primary power source and a secondary power source. The graph 700 is an example of the power consumption when it is determined that the electronic device is in the second thermal zone 440 shown in FIG. 4. The graph 700 shows a percent battery usage 710, system temperature 720 of an electronic device, and a thermal shutdown limit 730 of the electronic device. In this example, utilization of the primary power source 740 and utilization of the secondary power source 750 is alternated to extend the run time of the electronic device. The ratio of the utilization of the primary power source 740 to the utilization of the secondary power source 750 (i.e., the power draw ratio) in this example is approximately 50:50. As shown in FIG. 7, the electronic device begins drawing power from the primary power source at point A. As the electronic device continues drawing power from the primary power source, the system temperature 760 gradually increases until it reaches point B. At point B, the electronic device switches from the primary power source to the secondary power source and begins drawing power from the secondary power source. As the electronic device continues drawing power from the secondary power source, the system temperature 760 gradually increases until it reaches point C. At point C, the electronic device switches from the secondary power source to the primary power source and begins drawing power from the primary power source. This process of drawing power by alternating from the primary power source and the secondary power source continues until point D. At point D, the thermal shutdown limit 730 of the system is exceeded and causes a forced shutdown of the system. Upon the forced shutdown of the system, the system temperature 760 gradually decreases as the system cools.

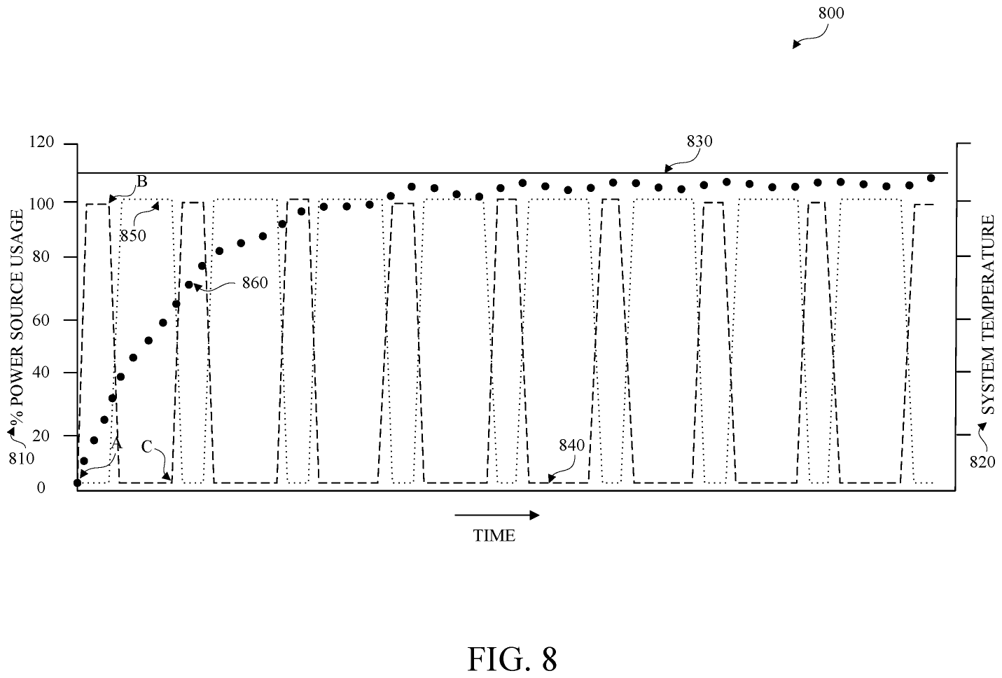

FIG. 8 is a graph 800 showing another example of power source consumption between a primary power source and a secondary power source. The graph 800 is another example of the power consumption when it is determined that the electronic device is in the second thermal zone 440 shown in FIG. 4. The graph 800 shows a percent battery usage 810, system temperature 820 of an electronic device, and a thermal shutdown limit 830 of the electronic device. In this example, utilization of the primary power source 840 and utilization of the secondary power source 850 is alternated to extend the run time of the electronic device. The ratio of the utilization of the primary power source 840 to the utilization of the secondary power source 850 (i.e., the power draw ratio) in this example is approximately 30:70. As shown in FIG. 8, the electronic device begins drawing power from the primary power source at point A. As the electronic device continues drawing power from the primary power source, the system temperature 860 gradually increases until it reaches point B. At point B, the electronic device switches from the primary power source to the secondary power source and begins drawing power from the secondary power source. As the electronic device continues drawing power from the secondary power source, the system temperature 860 gradually increases until it reaches point C. At point C, the electronic device switches from the secondary power source to the primary power source and begins drawing power from the primary power source. This process of drawing power by alternating from the primary power source and the secondary power source continues until one of the power sources is depleted or the thermal shutdown limit 830 of the system is exceeded and causes a forced shutdown of the system.

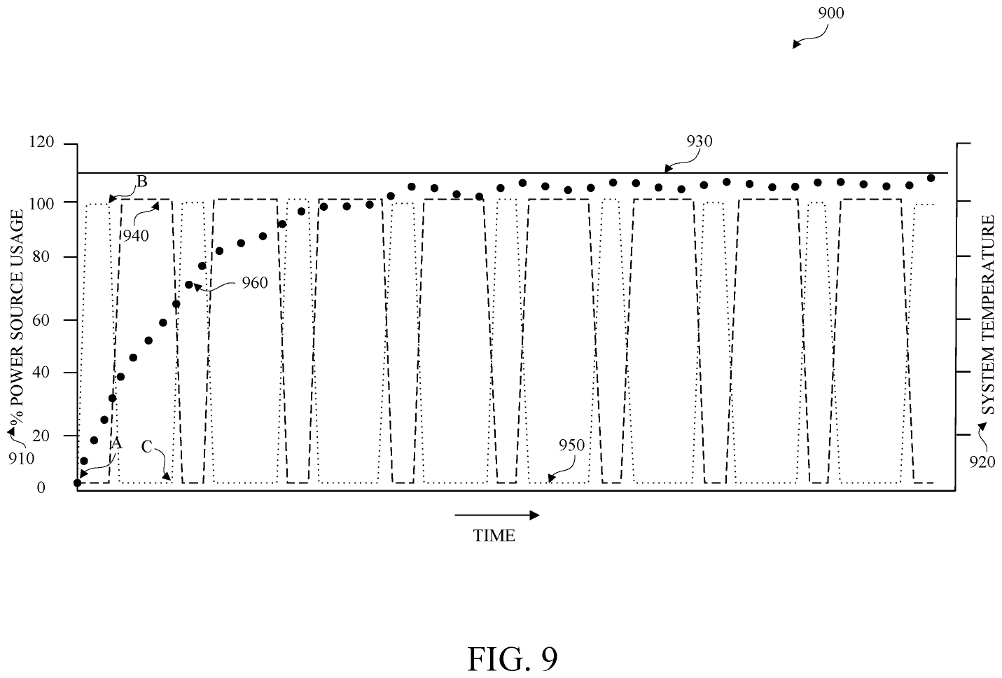

FIG. 9 is a graph 900 showing another example of power source consumption between a primary power source and a secondary power source. The graph 900 is another example of the power consumption when it is determined that the electronic device is in the second thermal zone 440 shown in FIG. 4. The graph 900 shows a percent battery usage 910, system temperature 920 of an electronic device, and a thermal shutdown limit 930 of the electronic device. In this example, utilization of the primary power source 940 and utilization of the secondary power source 950 is alternated to extend the run time of the electronic device. The ratio of the utilization of the primary power source 940 to the utilization of the secondary power source 950 (i.e., the power draw ratio) in this example is approximately 70:30. As shown in FIG. 9, the electronic device begins drawing power from the secondary power source at point A. In some examples, the electronic device may begin drawing power from the primary power source. As the electronic device continues drawing power from the secondary power source, the system temperature 960 gradually increases until it reaches point B. At point B, the electronic device switches from the secondary power source to the primary power source and begins drawing power from the primary power source. As the electronic device continues drawing power from the primary power source, the system temperature 960 gradually increases until it reaches point C. At point C, the electronic device switches from the primary power source to the secondary power source and begins drawing power from the secondary power source. This process of drawing power by alternating from the primary power source and the secondary power source continues until one of the power sources is depleted or the thermal shutdown limit 930 of the system is exceeded and causes a forced shutdown of the system.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device comprising:
an image sensor configured to obtain an input image;
a primary power source;
a secondary power source; and
a processor configured to:
obtain an internal temperature measurement of the image capture device;
determine a thermal zone based on the internal temperature measurement;
on a condition that the determined thermal zone is a first thermal zone, draw power from the secondary power source;
on a condition that the determined thermal zone is a second thermal zone, alternately draw power from the primary power source and the secondary power source; and
on a condition that the determined thermal zone is a third thermal zone, draw power from the secondary power source.

2. The image capture device of claim 1, wherein the processor is further configured to draw power from the primary power source on a condition that the secondary power source is depleted.

3. The image capture device of claim 1, wherein the first thermal zone indicates that an internal temperature of the image capture device is below a risk of overheating threshold (ROOT) and that the processor is not at risk of overheating.

4. The image capture device of claim 1, wherein the second thermal zone indicates that an internal temperature of the image capture device is above a risk of overheating threshold (ROOT).

5. The image capture device of claim 4, wherein the second thermal zone indicates that the internal temperature of the image capture device will exceed a thermal limit of the processor on a condition that the primary power source is used exclusively.

6. The image capture device of claim 1, wherein the third thermal zone indicates that an internal temperature of the image capture device is above a threshold and approaching a thermal limit of the processor.

7. The image capture device of claim 1, wherein on a condition that the determined thermal zone is the second thermal zone, the processor is configured to alternately draw power from the primary power source and the secondary power source at a substantially 50:50 ratio.

8. The image capture device of claim 1, wherein on a condition that the determined thermal zone is the second thermal zone the processor is configured to alternately draw power from the primary power source and the secondary power source at a substantially 30:70 ratio.

9. The image capture device of claim 1, wherein on a condition that the determined thermal zone is the second thermal zone, the processor is configured to dynamically adjust a power draw ratio to alternately draw power from the primary power source and the secondary power source.

10. The image capture device of claim 9, wherein the processor is further configured to dynamically adjust the power draw ratio based on a power source type, a power source capacity, power source health, power source age, an electronic device type, or a processor power requirement.

11. An electronic device comprising:
a sensor configured to obtain an internal temperature measurement of the electronic device;
a primary power source;
a secondary power source; and
a processor configured to:
determine a thermal zone based on the internal temperature measurement;
on a condition that the determined thermal zone is a first thermal zone, draw power from the secondary power source;
on a condition that the determined thermal zone is a second thermal zone, alternately draw power from the primary power source and the secondary power source; and
on a condition that the determined thermal zone is a third thermal zone, draw power from the secondary power source.

12. The electronic device of claim 11, wherein the primary power source is an internal battery and the secondary power source is an external battery.

13. The electronic device of claim 11, wherein the primary power source is an external battery and the secondary power source is an internal battery.

14. The electronic device of claim 11, wherein the first thermal zone indicates that an internal temperature of the electronic device is below a risk of overheating threshold (ROOT) and that the processor is not at risk of overheating.

15. The electronic device of claim 11, wherein the second thermal zone indicates that an internal temperature of the electronic device is above a risk of overheating threshold (ROOT) and that the internal temperature of the electronic device will exceed a thermal limit of the processor on a condition that the primary power source is used exclusively.

16. The electronic device of claim 11, wherein the third thermal zone indicates that an internal temperature of the electronic device is above a risk of overheating threshold and approaching a thermal limit of the processor.

17. The electronic device of claim 11, wherein on a condition that the determined thermal zone is the second thermal zone, the processor is configured to dynamically adjust a power draw ratio to alternately draw power from the primary power source and the secondary power source.

18. A method comprising:
obtaining an internal temperature measurement of an electronic device;
determining a thermal zone based on the internal temperature measurement;
on a condition that the determined thermal zone is a first thermal zone, drawing power from an external power source of the electronic device;
on a condition that the determined thermal zone is a second thermal zone, alternately drawing power from an internal power source of the electronic device and the external power source; and
on a condition that the determined thermal zone is a third thermal zone, drawing power from the external power source.

19. The method of claim 18, wherein the first thermal zone indicates that an internal temperature of the electronic device is below a risk of overheating threshold (ROOT) and a processor of the electronic device is not at risk of overheating, wherein the second thermal zone indicates that the internal temperature of the electronic device will exceed a thermal limit of the processor on a condition that the primary power source is used exclusively, and wherein the third thermal zone indicates that the internal temperature of the electronic device is above the ROOT and approaching a thermal limit of the processor.

20. The method of claim 18 further comprising:
on a condition that the determined thermal zone is the second thermal zone, dynamically adjusting a power draw ratio to alternately draw power from the primary power source and the external power source.
